(19) United States
(12) Patent Application Publication
(10) Pub. No.: US 2018/0049577 A1
(43) Pub. Date: Feb. 22, 2018

(54) Slow cooker with a touch and slide screen

(71) Applicant: Ningbo Jinyu Electric Appliance Co., Ltd., Zhejiang (CN)

(72) Inventors: Zhongyu SHI, Zhejiang (CN); Junda SHI, Zhejiang (CN); Shukuo LIU, Zhejiang (CN)

(21) Appl. No.: 15/336,805

(22) Filed: Oct. 28, 2016

(30) Foreign Application Priority Data
Aug. 19, 2016 (CN) 201610715404.8

(51) Int. Cl. A47J 27/00; H05B 1/02

(52) U.S. Cl. CPC A47J 27/002; G06F 3/041; H05B 1/0261

(57) ABSTRACT

A slow cooker with a touch and slide screen, having a base, an outer shell on the base; a slot at a middle part of the base; a power box inside the slot; a PCB power board inside the power box; a power box cover at a bottom part of the power box; an aluminum pot inside the outer shell; a heating ring on the aluminum pot; a ceramic pot nested within the aluminum pot; a glass cover on the ceramic pot; a first high temperature wire and a second high temperature wire on the heating ring; second ends of the first and second high temperature wires are connected with the PCB power board; a bottom part of a front surface of the outer shell has a square mounting hole, in which a PCB display rear cover is embedded; a PCB display is mounted on the PCT display rear cover.

### BACKGROUND OF THE INVENTION

The present invention relates to the technical field of slow cooker, and more specifically relates to a slow cooker with a touch and slide screen.

A slow cooker is a kind of cooking utensil. It is widely used because food stuff can be heated evenly and the cooked food tastes delicious. A slow cooker generally has heating parts inside an insulating shell. Also, it has a cooking pot (usually a ceramic pot) and a glass cover. A basic cooking principle of the slow cooker is heat conduction. Heat energy produced by the heating parts inside the slow cooker will be slowly and evenly conducted to the cooking pot. Therefore, user is not required to monitor the slow cooker during long hours of cooking. The use of indirect heat source allows the food to be heated up evenly, the food will be cooked and stewed slowly to preserve the original tastes and flavors of the food. A conventional slow cooker has the following disadvantages: firstly, a conventional slow cooker is not equipped with any computer display panel, and so a real-time operating condition of the slow cooker cannot be shown; secondly, a conventional slow cooker only has an on/off switch, and so it is not possible to control the cooking time; this limited function of the slow cooker causes inconvenience and waste of energy during use, and also fails to go green because it cannot choose different cooking hours based on different types of food.

### BRIEF SUMMARY OF TH E INVENTION

In view of the aforesaid disadvantages now present in the prior art, the present invention provides a slow cooker with a touch and slide screen having a simple structure and a reasonable design. The present invention provides a PCB display panel on an outer shell of the cooker to achieve a structurally simple and low cost solution to control a touch and slide screen by a computer board to facilitate manual adjustment of different cooking times, thereby significantly enhancing working efficiency.

A slow cooker with a touch and slide screen, comprising a base; an outer shell is provided on the base; a middle part of the base is provided with a slot; a power box is provided inside the slot; a PCB power board is, provided inside the power box; a bottom part of the power box is provided with a power box cover.

An aluminum pot is provided inside the outer shell; a heating ring is provided on the aluminum, pot; a ceramic pot is nested within the aluminum pot; a glass cover is provided on the ceramic pot; a first high temperature wire and a second high temperature wire are provided on the heating ring; a second end of the first high temperature wire and a second end of the second high temperature wire are connected with the PCB power board.

A bottom part of a front surface of the outer shell is provided with a square mounting hole; a PCB display rear cover is embedded into the square mounting hole; a PCB display is mounted on the PCT display rear cover; a control panel is provided on the PCB display.

Further, a carrying handle is provided at each of a left side and a right side of the outer shell.

Further, each of four corners of a bottom surface of the base is provided with an extension being a support leg; a bottom surface of each support leg is provided with a silicon leg support.

Further, a cover handle is provided on the glass cover.

Further, the control panel comprises a touch and slide screen; an upper part of the touch and slide screen is provided with a digital time indication section; a lower part of the touch and slide screen corresponding to the digital time indication section is provided with a graphical indication section.

The present invention has the following beneficial effects by adopting the above structures: the slow cooker with a touch and slide screen provided by the present invention provides a PCB display panel on an outer shell of the cooker to achieve a structurally simple and low cost solution to control a touch and slide screen by a computer board to facilitate manual adjustment of different cooking times, thereby significantly enhancing working efficiency.

### BRIEF DESCRIPTION OF THE DRAWINGS

The drawings described herein are part of the invention for further understanding of the present invention, and should not constitute any improper limitation to the present invention.

FIG. 1 is an explosive view showing a structure of the present invention.

FIG. 2 is a structural view of the control panel of the present invention.

### REFERENCES IN THE FIGURES

1: cover handle; 2: glass cover; 3: ceramic pot; 4: aluminum pot; 5: carrying handle; 6: outer shell; 7: base; 8: power line; 9: silicon leg support; 10: first high temperature wire; 11: second high temperature wire; 12: heating ring; 13: PCB display; 14: control panel; 14-1: digital time indication section; 14-2: graphical indication section; 15: power box; 16: PCB power board; 17: power box cover; 18: PCB display rear cover.

### DETAILED DESCRIPTION OF THE INVENTION

The present invention will be described in detail below with reference to an embodiment and the accompanying figures. The illustrative embodiment and the description are intended only for the understanding of the present invention and should not limit the, present invention.

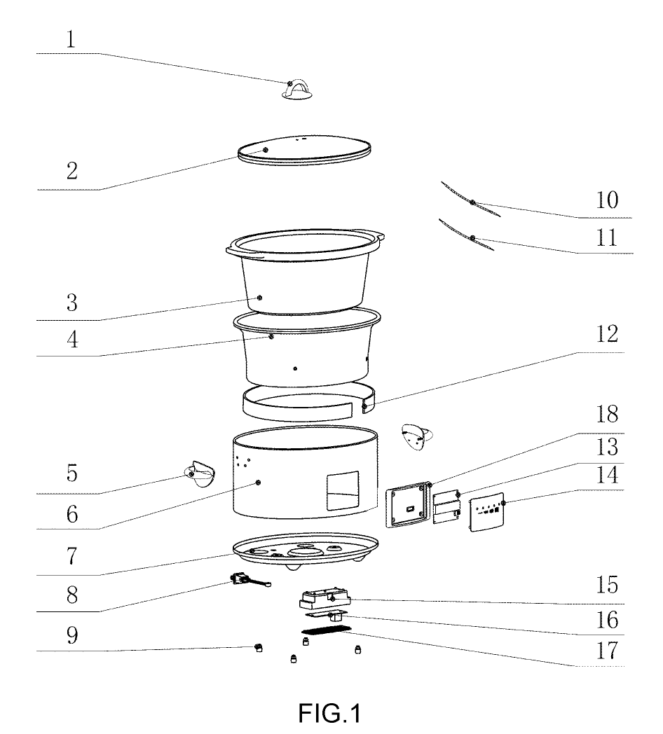

As shown in FIG. 1, a slow cooker with a touch and slide screen comprises a base 7, an outer shell 6 is provided on the base 7; a middle part of the base 7 is provided with a slot; a power box 15 is provided inside the slot; a PCB power board 16 is provided inside the power box 15; a bottom part of the power box 15 is provided with a power box cover 17.

An aluminum pot 4 is, provided inside the outer shell 6; a heating ring 12is provided on the aluminum pot 4; a ceramic pot 3 is nested within the aluminum pot 4; a glass cover 2 is provided on the ceramic pot 3; a first high temperature wire 10 and a second high temperature wire 11 are provided on the heating ring 12; a second end of the first high temperature wire 10 and a second end of the second high temperature wire 11 are connected with the PCB power board 16.

A bottom part of a front surface of the outer shell 6 is provided with a square mounting hole; a PCB display rear cover 18 is embedded into the square mounting hole; a PCB display 13 is mounted on the PCT display rear cover 18; a control panel 14 is provided on the PCB display 13.

Preferably, a carrying handle 5 is provided at each of a left side and a right side of the outer shell 6.

Preferably, each of four corners of a bottom surface of the base 7 is provided with an extension being a support leg; a bottom surface of each support leg is provided with a silicon leg support 9.

Preferably, a cover handle 1 is provided on the glass cover 2.

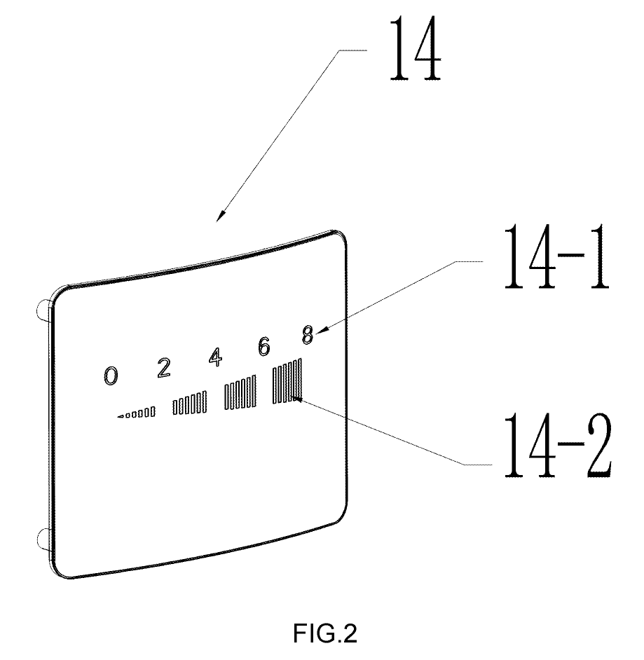

Preferably, as shown in FIG. 2, the control panel 14 comprises a touch and slide screen; an upper part of the touch and slide screen is provided with a digital time indication section 14-1; a lower part of the touch and slide screen corresponding to the digital time indication section 14-1 is provided with a graphical indication section 14-2.

During use of the present invention, the first high temperature wire 10 and the second high temperature wire 11 are supplied with power by the PCB power board 16. The first high temperature wire 10 and the second high temperature wire 11 are connected with the heating ring 12; when the heating ring 12 starts working, the aluminum pot 4 will have an increased temperature, and such heat of the aluminum pot 4 will be conducted to the ceramic port 3 so as to cook and stew the food in the ceramic pot 3 slowly. In order to control the cooking time of different types of food, a bottom part of a front surface of the outer shell 6 is provided with a square mounting hole; a PCB display rear cover 18 is embedded into the square mounting hole; a PCB display 13 is mounted on the PCT display rear cover 18; and a control panel 14 is provided on the PCB display 13. The control panel 14 is a touch and slide screen; a touch and slide screen has a digital time indication section (represented by numbers 0, 2, 4, 6 and 8; for example, 0-2 represents two hours, meaning that a time interval between two adjacent numbers is two hours); a lower part of the touch and slide screen corresponding to the digital time indication section 14-1 is provided with a graphical indication section 14-2. The touch and slide screen can also be configured by the control panel 14 so that different cooking times can be configured.

The present invention also uses a computer board so that the cooking time is clearly visible. Convenience can be achieved by touch and slide operation. A surface of the control panel 14 has a digital time indication section and a graphical indication section 14-2 corresponding to the digital time indication section 14-1. As such, a user can choose 4 different types of cooking time duration so that the cooking time may be short or may be long, thereby significantly enhancing the working efficiency and facilitate its use by a user.

The present invention solves the problem of lacking an operation and display using a touch and slide screen in the prior art slow cooker. In actual use, such a prior art slow cooker is not convenient to use. By providing this additional feature, the present invention is very convenient to use, and its appearance is beautiful as well.

The slow cooker with a touch and slide screen provided by the present invention provides a PCB display panel on an outer shell of the cooker to achieve a structurally simple and low cost solution to control a touch and slide screen by a computer board to facilitate manual adjustment of different cooking times, thereby significantly enhancing working efficiency.

The above description illustrates only a preferred embodiment of the present invention. Any changes or modification with equivalent effect made within the scope of the present invention with respect to the structures, features or principles of the present invention should also fall within the scope of the present invention.

What is claimed is:

1. A slow cooker with a touch and slide screen, comprising a base; an outer shell is provided on the base; a middle part of the base is provided with a slot; a power box is provided inside the slot; a PCB power board is provided inside the power box; a bottom part of the power box is provided with a power box cover; an aluminum pot is provided inside the outer shell; a heating ring is provided on the aluminum pot; a ceramic pot is nested within the aluminum pot; a glass cover is provided on the ceramic pot; a first high temperature wire and a second high temperature wire are provided on the heating ring; a second end of the first high temperature wire and a second end of the second high temperature wire are connected with the PCB power board; a bottom part of a front surface of the outer shell is provided with a square mounting hole; a PCB display rear cover is embedded into the square mounting hole; a PCB display is mounted on the PCT display rear cover; a control panel is provided on the PCB display.

2. The slow cooker with a touch and slide screen as in claim 1 wherein a carrying handle is provided at each of a left side and a right side of the outer shell.

3. The slow cooker with a touch and slide screen as in claim 1 wherein each of four corners of a bottom surface of the base is provided with an extension being a support leg; a bottom surface of each support leg is provided with a silicon leg support.

4. The slow cooker with a touch and slide screen as in claim 1, wherein a cover handle is provided on the glass cover.

5. The slow cooker with a touch and slide screen as in claim 1, wherein the control panel comprises a touch and slide screen; an upper part of the touch and slide screen is provided with a digital time indication section; a lower part of the touch and slide screen corresponding to the digital time indication section is provided with a graphical indication section.
